(19) United States
(12) Patent Application Publication
(10) Pub. No.: US 2026/0119165 A1
(43) Pub. Date: Apr. 30, 2026

(54) Systems and methods for selectively generating an alert

(71) Applicant: Canva Pty Ltd, Surry Hills (AU)

(72) Inventors: Guy Lawrence NEEDHAM, Erskineville (AU); Thi Hanh Nguyen NGUYEN, Beverly Hills (AU); Yunlong WANG, Melbourne (AU); Giselle Eliana MONTAMAT, Annandale (AU); Leesa Francis WOCKNER, Moorooka (AU); Chathura Dasun Chamara Widanage WIDANALAGE, Adelaide (AU); Long Hung NGUYEN, Sydney (AU)

(73) Assignee: Canva Pty Ltd, Surry Hills (AU)

(21) Appl. No.: 19/224,820

(22) Filed: Jun. 1, 2025

(30) Foreign Application Priority Data
Oct. 31, 2024 (AU) 2024259637

(51) Int. Cl. G06F 8/71; G06F 8/65

(52) U.S. Cl. CPC G06F 8/71; G06F 8/65

(57) ABSTRACT

Described herein is a computer implemented method for generating an alert based on a product update for a software system, the product update including a first product update variant of the software system and a product update control of the software system, the method including: receiving user interaction event data based on one or more user interaction events from a plurality of users of the software system, the plurality of users including a first subset of users using the first product update variant and a second subset of users using the product update control; processing the user interaction event data to determine if any of the one or more user interaction events is an exposure event; based on the user interaction event data of any determined exposure events, determining, for each of the first product update variant and product update control, a respective user metric dataset for a user metric; calculating, for the first product update variant and product update control, respective probability input data in respect of the user metric based on the respective user metric datasets; based on the probability input data, calculating, for the first product update variant and product update control, a first variant estimation model and a control estimation model respectively; deriving a first change value distribution based on the first variant estimation model and the control estimation model such that the first change value distribution defines probability of relative uplift or downlift of user interactions; calculating a first impact value based on first change value distribution and a predefined time value t; comparing the calculated first impact value with a predefined impact value threshold; and based on this comparison, generating a first alert condition.

### CROSS-REFERENCE TO RELATED APPLICATION

This application is a U.S. Non-Provisional Application that claims priority to Australian Patent Application No. 2024259637, filed Oct. 31, 2024, which is hereby incorporated by reference in its entirety.

### TECHNICAL FIELD

Aspects of the present disclosure are directed to systems and methods for selectively generating an alert based on a generated estimate of user interactions.

### BACKGROUND

Commercial software products are widely utilised and may serve extremely wide-ranging functions. Those products are accessed by users who wish to utilise the specific functionality that a product offers. Specific products may be periodically updated by the product administrator for a variety of reasons. For instance, a product may be updated to fix a bug in the functioning of the product, provide additional security to any personal or private information of the product proprietor and/or its users, and rectify a security vulnerability of the product. Products may also be updated with new or improved features that may, for example, be aimed at enhancing user experience and/or enticing users to take up additional features that may be offered on a higher level subscription.

Product administrators may also monitor certain actions of its users and in some cases record user actions, for example the number of times a certain feature of the product is used. When a new or improved feature is released, an administrator may be interested in monitoring actions of its users in relation to the new or improved feature, as well as monitoring the overall use of the product. This can effectively provide feedback on the popularity of the new or improved feature including the potential effect of the release of the new or improved feature on the overall usage of the product.

### SUMMARY

Described herein is a computer implemented method for generating an alert based on a product update for a software system, the product update including a first product update variant of the software system and a product update control of the software system, the method including: receiving user interaction event data based on one or more user interaction events from a plurality of users of the software system, the plurality of users including a first subset of users using the first product update variant and a second subset of users using the product update control; processing the user interaction event data to determine if any of the one or more user interaction events is an exposure event; based on the user interaction event data of any determined exposure events, determining, for each of the first product update variant and product update control, a respective user metric dataset for a user metric; calculating, for the first product update variant and product update control, respective probability input data in respect of the user metric based on the respective user metric datasets; based on the probability input data, calculating, for the first product update variant and product update control, a first variant estimation model and a control estimation model respectively; deriving a first change value distribution based on the first variant estimation model and the control estimation model such that the first change value distribution defines probability of relative uplift or downlift of user interactions; calculating a first impact value based on first change value distribution and a predefined time value t; comparing the calculated first impact value with a predefined impact value threshold; and based on this comparison, generating a first alert condition.

### BRIEF DESCRIPTION OF THE DRAWINGS

In the drawings:

FIG. 1 is a diagram depicting a networked environment in which various features of the present disclosure may be performed.

FIG. 2 is a block diagram of an example computer processing system.

FIG. 3 depicts example representations of a graphical user interface.

FIG. 4 is a flowchart depicting operations performed to determine a likelihood factor for a product update.

FIG. 5 is a flowchart depicting operations performed to generate an alert in respect of a product update.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

As described above, administrators of commercial software products (also referred to as a software system) may monitor certain actions of its users. A commercial software product may, in one example, be a software-based graphic design platform for providing functionality to creating and edit graphic designs for various uses and applications. The graphic design platform provides certain features that can be selectively utilised by users for creating and/or editing graphic designs. Such features may include templates (that provide a user with a starting point from which to create their own graphic design or visual presentation) and/or stock media items (such as photographs, graphics, videos, audio clips, and/or other types of media items which a user may add to a design being created or edited). Editing operations performed in respect of graphic designs may include applying a graphic effect, e.g. adding elements (e.g. an image such as a clip art image, text, shapes, etc.) blurring or blacking out some or all of a graphic design, moving around visual features of a graphic design. From time to time, existing features may be changed (e.g. a change in the contents of a certain template) and/or new features may be added (e.g. a new type of graphic effect) to the graphic design platform. Any feature change or new feature added will be referred to herein as a product update. Further, the existing features of the software system prior to a product update may be referred to as original features.

As also discussed above, administrators may also monitor certain actions of its users (i.e. user interactions) and present examples may record actions in order to obtain feedback. When a product update is implemented, the monitoring and recording of user interactions may be used to measure the effect that the product update may have on a user's experience including the popularity of the product update based on the feedback.

The systems and methods disclosed herein are generally concerned with monitoring user interactions associated with one or more product updates by a product monitoring platform and selectively generating an alert based on a generated estimate of user interactions. The product monitoring platform may calculate estimations of user interactions based on the monitored user interactions. Further, calculated estimations of user interactions may be used to calculate an impact value of the one or more product updates such that an alert may be generated based on the impact value (which will be explained in detail further below).

In the present context, a product monitoring platform is a system (or a set of systems) that operates to monitor user interactions (referred to herein as user interaction events) with a software product (e.g. a graphic design platform), calculate estimations of user interactions with that software product that may occur in future, and/or calculate an impact value based on the estimations of user interactions. The impact value may subsequently be used to generate an alert based on a comparison of the impact value with an impact value threshold. Product monitoring platforms may operate solely to perform these operations or may also provide additional services or functions.

A software product (e.g. a graphic design platform), includes a plurality of registered users that are able to access and utilise the functionality of the software product. A registered user may be identified by a unique user ID or a registered user may be associated with a specific client system having a unique device ID.

In the embodiments described herein, user interaction events monitored by a product monitoring platform are associated with user interaction event data. Generally speaking, user interaction event data includes information indicating that one or more user interaction events has occurred. User interaction event data may be used to calculate user metrics and calculate estimations of future user interaction events based on calculated user metrics.

User metrics include statistical counts of certain user interaction events or statistical counts of certain combinations of user interaction events. User metrics thus are based on user interaction event data indicating one user interaction event or user interaction event data indicating multiple user interaction events. A user metric may take the form of a value, e.g. an integer that is equivalent to a total count of user interaction events of which the user metric is based. Therefore, the user metric may be based on a user metric dataset that comprises one or more instances of user metric data. In present examples, an instance of user metric data may correspond to an instance of user interaction event data.

There may be two types of user metrics: positive user metrics; and negative user metrics. Positive user metrics are based on user interaction events that are deemed to be positive to the user experience or engagement in relation to the software system. In embodiments described here where a product monitoring platform monitors a graphic design platform, positive user metrics may include, for example: a number of distinct trials of or subscriptions to the graphic design platform that are commenced; a number of distinct times a certain feature of the graphic design platform was used; and a number of distinct times a graphic design created/edited/accessed on the graphic design platform was published or shared. Negative user metrics are based on user interaction events that are deemed to be negative to the user experience or engagement in relation to the software system. In embodiments described here where a product monitoring platform monitors a graphic design platform, negative user metrics may include, for example: a number of distinct subscription(s) to the graphic design platform that are cancelled; and a number of times the graphic design platform crashes.

While a graphic design platform with the specific data described above are provided as an example, the techniques described herein may be applied (or be adapted to be applied) to other types of product monitoring platforms, other types of user interactions and/or user metrics associated with other types of data.

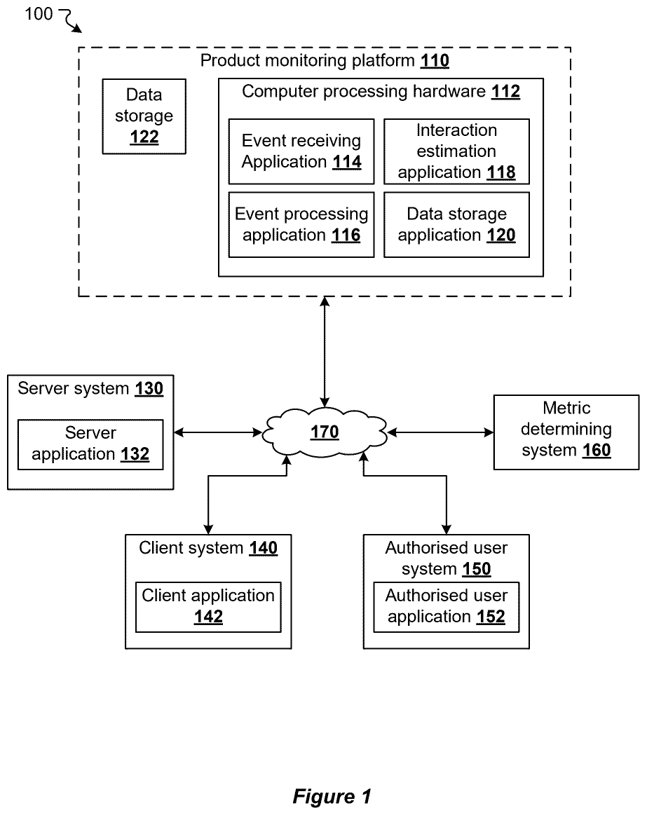

The techniques disclosed herein are computer implemented techniques that are performed by one or more computer processing systems. Referring initially to FIG. 1, a networked environment 100 is depicted in which various features of the present disclosure may be implemented.

Networked environment 100 includes a product monitoring platform 110, a server system 130, a client system 140, an authorised user system 150 and a metric determination system 160 all of which communicate via one or more communications networks 170 (e.g. the Internet).

Generally speaking, product monitoring platform 110 is a computer processing system including computer processing hardware 112 (discussed below). Computer processing hardware 112 is configured to perform the functions described herein by execution of one or more software applications—that is, computer readable instructions that are stored in a storage device (such as non-transitory memory 210 described below) and executed by a processing unit of the system 100 (such as processing unit 202 described below). In the present example, product monitoring platform 110 includes an event receiving application 114, an event processing application 116, an interaction estimation application 118 and a data storage application 120. However, in other embodiments, the functionality provided by two or more of event receiving application 114, event processing application 116, interaction estimation application 118 and data storage application 120 may be provided by a single application of product monitoring platform 110. For example, in an embodiment, the functionality of event receiving application 114 and interaction estimation application 118 may carried out by a single application. Broadly speaking, product monitoring platform 110 is configured to receive and process user interaction event data (either from client system 140 or server system 130).

In the present example, the data storage application 120 executes to receive and process requests to persistently store and retrieve data relevant to the operations performed/services provided by product monitoring platform 110. Such requests may be received from event receiving application 114, event processing application 116, interaction estimation application 118 and/or other server environment applications, and/or (in some instances) directly from one or more applications external to product monitoring platform 110 (such as server application 132, client application 142 and/or authorised user application 152). Data relevant to the operations performed/services provided by product monitoring platform 110 may include, for example, user metric data, user interaction event data, template design data (e.g. templates that can be used by users to create designs), design element data (e.g. data in respect of stock elements that users may add to designs), and/or other data relevant to the operation of the server environment 110.

Data storage application 120 may, for example, be a relational database management application or an alternative application for storing and retrieving data from data storage 122. Data storage 122 may be any appropriate data storage device (or set of devices), for example one or more non-transient computer readable storage devices such as hard disks, solid state drives, tape drives, or alternative computer readable storage devices.

In product monitoring platform 110, event receiving application 114, event processing application 116 and/or interaction estimation application 118 persistently stores data to data storage device 122 via data storage application 120. In alternative implementations, however, event receiving application 114, event processing application 116 and/or interaction estimation application 118 may be configured to directly interact with data storage devices such as 122 to store and retrieve data (in which case a separate data storage application may not be needed). Furthermore, while a single data storage application 120 is described, product monitoring platform 110 may include multiple data storage applications. For example one data storage application 122 may be used for a first set of user metric data (related to a first metric), another for a second set of user metric data (related to a second metric), another for design element data and so forth. In this case, each data storage application may interface with one or more shared data storage devices and/or one or more dedicated data storage devices, and each data storage application may receive/respond to requests from various applications (including, for example event receiving application 114, event processing application 116 and/or interaction estimation application 118).

As noted, product monitoring platform 110 applications run on (or are executed by) computer processing hardware 112. Computer processing hardware 112 includes one or more computer processing systems. The precise number and nature of those systems will depend on the architecture of product monitoring platform 110.

For example, in one implementation each application of product monitoring platform 110 may run on its own dedicated computer processing system. In an alternative implementation, two or more product monitoring system applications may run on a common/shared computer processing system. In a further alternative implementation, product monitoring platform 110 is a scalable environment in which application instances (and the computer processing hardware 112—i.e. the specific computer processing systems required to run those instances) are commissioned and decommissioned according to demand—e.g. in a public or private cloud-type system. In this case, product monitoring platform 110 may simultaneously run multiple instances of each application (on one or multiple computer processing systems) as required by client demand. Where product monitoring platform 110 is a scalable system it will include additional applications to those illustrated and described. As one example, product monitoring platform 110 may include a load balancing application which operates to determine demand, direct client traffic to the appropriate application 114 (e.g. where multiple event receiving applications 114, event processing applications 116 and/or interaction estimation application 118 have been commissioned), trigger the commissioning of additional server environment applications (and/or computer processing systems to run those applications) if required to meet the current demand, and/or trigger the decommissioning of server environment applications (and computer processing systems) if they are not functioning correctly and/or are not required for current demand.

Communication between the applications and computer processing systems of product monitoring platform 110 may be by any appropriate means, for example direct communication or networked communication over one or more local area networks, wide area networks, and/or public networks (with a secure logical overlay, such as a VPN, if required).

Generally speaking, server system 130 also includes computer processing hardware on which applications that provide server-side functionality to client applications such as client application 142 and authorised user application 152 (each described below) execute. In the present example, server environment 110 includes a server application 132. In present embodiments, server system 130 may be a graphic design platform. However, in other embodiments, server system 130 may be a server system other than that of a graphic design platform, e.g. a media streaming service, or a social media platform.

In the present embodiment, server application 132 executes to provide a client application (and authorised user application) endpoint that is accessible over communications network 170. For example, where server application 132 serves web browser client applications server application 132 will collectively be a web server which receives and responds (for example) to HTTP requests. Where server application 132 serves native client applications, server application 132 will be an application server configured to receive, process, and respond to specifically defined API calls received from those client applications. Server system 130 may include one or more web server applications and/or one or more application server applications allowing it to interact with both web and native client applications.

In the present example where server system 130 is a graphic design platform, server application 132 (and/or other applications of server system 130) facilitate various functions related to digital designs. These may include, for example, design creation, editing including animating, storage, organisation, searching, storage, retrieval, viewing, sharing, publishing, and/or other functions related to digital designs. The server application 132 (and/or other applications) may also facilitate additional, related functions such as user account creation and management, user group creation and management, user and user group permission management, user authentication, and/or other server side functions.

In this embodiment, product monitoring platform 110 is separate and remote from server system 130. However, in other embodiments, product monitoring platform 110 may be implemented as part of server system 130.

Client system 140 hosts a client application 142 which, when executed by client system 140, configures client system 140 to provide client-side functionality/interact with server system 130 (or, more specifically, server application 132 and/or other applications provided by server system 130). Via client application 142, a user can make use of the various functionality of server system 130. For example, where server system 130 is a graphic design platform, a user can make use of the various functions of the graphic design platform via client application 142. In present examples, client system 140 may be used by a registered user of server system 130 (i.e. the software product).

Authorised user system 150 hosts an authorised user application 152 which, when executed by authorised user system 150, configures authorised user system 150 to provide authorised user-side functionality/interact with product monitoring platform 110 (or, more specifically, event receiving application 114, event processing application 116, interaction estimation application 118 and/or other applications provided by product monitoring platform 110) and server system 130 (or, more specifically, server application 132 and/or other applications provided by server system 130). Via authorised user application 152, and as discussed in detail below, an authorised user can make use of the various techniques and features described herein. In the present context, an authorised user may include an administrator of product monitoring platform 110 and/or server system 130. In the present context, an authorised user is distinct from a registered user.

Networked environment 100 may further include other third party systems, such as metric determining system 160 (discussed below). Metric determining system 160 communicates with product monitoring platform 110 via network 170. In this embodiment, metric determining system 160 is located remotely to product monitoring platform 110. However, in other embodiments, metric determining system 160 may be implemented as part of product monitoring platform 110 or server system 130. Further, in other embodiments, networked environment 100 may include third party systems in addition to metric determining system 160.

The present disclosure describes various operations that are performed by applications of product monitoring platform 110. Generally speaking, however, operations described as being performed by a particular application (e.g. event receiving application 114, event processing application 116 and/or interaction estimation application 118) could be performed by (or in conjunction with) one or more alternative applications, and/or operations described as being performed by multiple separate applications could in some instances be performed by a single application.

The techniques and operations described herein are performed by one or more computer processing systems.

By way of example, client system 140 and/or authorised user system 150 may be any computer processing system which is configured (or configurable) by hardware and/or software—e.g. client application 142 and/or authorised user application 152—to offer the relevant functionality. For example, a client system 130 and/or an authorised user system 150 may be a desktop computer, laptop computer, tablet computing device, mobile/smart phone, or other appropriate computer processing system.

Similarly, the applications of product monitoring platform 110 and/or server system 130 are also executed by one or more computer processing systems (e.g. computer processing hardware such as 112 for product monitoring platform 110). Such computer processing systems will typically be server systems, though again may be any appropriate computer processing systems.

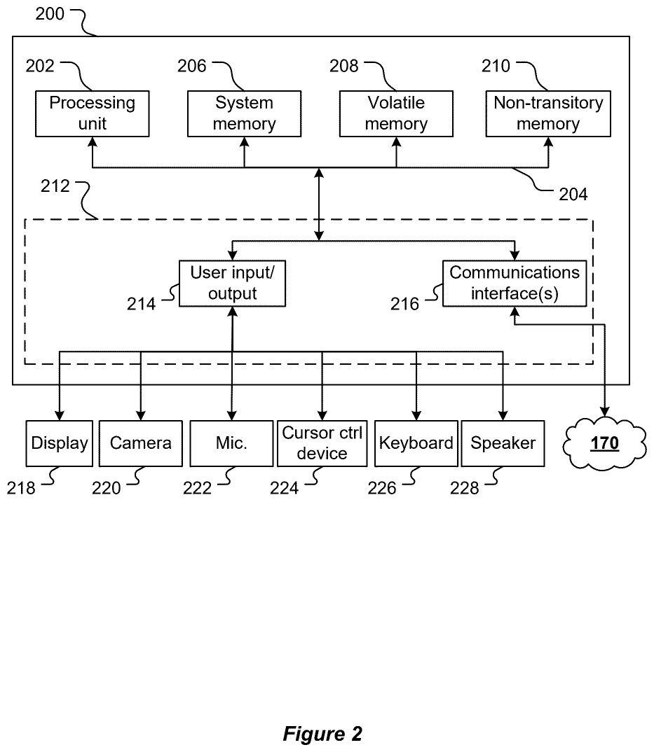

FIG. 2 provides a block diagram of a computer processing system 200 configurable to implement embodiments and/or features described herein. System 200 is a general purpose computer processing system. It will be appreciated that FIG. 2 does not illustrate all functional or physical components of a computer processing system. For example, no power supply or power supply interface has been depicted. However system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable (either in a shared or dedicated manner) by system 200.

Through a communications bus 204 the processing unit 202 is in data communication with a one or more machine readable storage (memory) devices which store computer readable instructions and/or data which are executed by the processing unit 202 to control operation of the processing system 200. In this example system 200 includes a system memory 206 (e.g. a BIOS), volatile memory 208 (e.g. random access memory such as one or more DRAM modules), and non-transient memory 210 (e.g. one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, the connection between the device and system 200 may be via wired or wireless hardware and communication protocols, and may be a direct or an indirect (e.g. networked) connection.

Generally speaking, and depending on the particular system in question, devices to which system 200 connects include one or more input devices to allow data to be input into/received by system 200 and one or more output devices to allow data to be output by system 200.

By way of example, where system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g. a mouse, trackpad, or other cursor control device), a keyboard 226, and a speaker device 228.

As another example, where system 200 is a portable personal computing device such as a smart phone or tablet it may include a touchscreen display 218, a camera device 220, a microphone device 222, and a speaker device 228.

As another example, where system 200 is a server computing device it may be remotely operable from another computing device via a communication network. Such a server may not itself need/require further peripherals such as a display, keyboard, cursor control device etc. (though may nonetheless be connectable to such devices via appropriate ports).

Alternative types of computer processing systems, with additional/alternative input and output devices, are possible.

System 200 also includes one or more communications interfaces 216 for communication with a network, such as network 170 of environment 100 (and/or a local network within the server environment 110). Via the communications interface(s) 216, system 200 can communicate data to and receive data from networked systems and/or devices.

System 200 stores or has access to computer applications (which may also be referred to as computer software or computer programs). Generally speaking, such applications include computer readable instructions and data which, when executed by the processing unit 202, configure system 200 to receive, process, and output data. Instructions and data can be stored on non-transient machine readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the networked environment of FIG. 1 above, product monitoring platform 110 includes one or more systems which run event receiving application 114, event processing application 116, interaction estimation application 118 and data storage application 120. Similarly, server system 130 runs a server application 132, client system 140 runs a client application 142 and authorised user system 150 runs an authorised user application 152.

In some cases, part or all of a given computer-implemented method will be performed by system 200 itself, while in other cases processing may be performed by other devices in data communication with system 200.

In the present context, a product monitoring platform monitors user interactions with server system 130 (e.g. a graphic design platform) by receiving user interaction event data in respect of user interaction events. A user interaction event may include, for example, interactions initiated by a user of the graphic design platform such as a user interacting with client system 140 via client application 142. Such user interaction events may include interactions that occur at client system 140 (e.g. a user being presented with a design platform feature displayed to the user on a graphical user interface) or interactions that occur at client system 140 to interact with server system 130 (e.g. a user using starting a subscription of the graphic design platform).

A user interaction event may be defined by an event schema. An event schema may take the form of data describing the user interaction of a user interaction event and thus may be used to determine that a user interaction has occurred. An event schema may represent a specific discrete user interaction that a user may be able to perform via client application 142. Thus, an event schema represents a specific user interaction a user may perform and a user interaction event occurrence is determined when a performed user interaction matches the event schema of that user interaction event.

In the context of a graphic design platform, a user interaction event may be, for example, using a certain feature type (e.g. a feature type may include discrete features “A”, “B” and “C”) of the graphic design platform and the event schema of this user interaction event may include a user selecting a specific button (e.g. a “feature A button”, a “feature B button” or a “feature C button”). For example, when a feature A button is selected by a user, this signifies that a user interaction event of the use of a certain feature type (in this case feature A which is of the certain feature type) has occurred. In another example, a user interaction event may be the use of a design template (e.g. one of “template A”, “template B”, “template C”), and the event schema of this user interaction event may include a user accessing a design template. For example, when template B is selected by a user, this signifies that a user interaction event of the use of a design template (in this case template B) has occurred.

Whilst in present embodiments a user interaction event may be defined by a single event schema, in alternate examples, a user interaction event may be defined by multiple event schemas. For instance, an alternate example of a user interaction event may be defined by a first event schema of selecting a design template and a second event schema of saving a design based on the selected design template. In this example, the user interaction event will only be taken to have occurred following both the first and second event schemas being satisfied.

Each instance of user interaction event data that corresponds to a user interaction event may also include: a time stamp attribute (representing the time at which the associated user interaction event occurred); a user ID attribute (e.g. the user ID of the registered user associated with user interaction event); a user device ID attribute (e.g. the user device ID of the specific client system associated with user interaction event); a hardware device attribute (representing the hardware device upon which the software product is running e.g. mobile phone, tablet, desktop computer etc.) and an operating system attribute (representing the operating system software upon which the software product is running e.g. iOS, Android, macOS, Windows, etc.), amongst others.

Therefore, user interaction event data may be generated based on a user interaction event occurring on a client system (e.g. client system 140). That is, user interaction event data may be generated based on functionality initiated by a user interaction performed on client system 140 via client application 142 that matches the event schema of a user interaction event.

Whilst in present embodiments a user interaction event may be generated based on a user interaction event performed on a client system (e.g. client system 140), in alternate examples, a user interaction event may be generated based on functionality performed on a server system (e.g. server system 130).

Therefore, in such embodiments, user interaction event data may be generated based on functionality initiated by a user interaction performed on client system 140 via client application 142 and also functionality performed on server system 130 via server application 132 that occurs in response to the user interaction on client system 140 that matches the event schema (or schemas) of the user interaction event.

An authorised user (e.g. an administrator of product monitoring platform 110 and/or server system 130) may make use of the various techniques and features provided by the functionality of authorised user application 152. In examples where server system 130 is a graphic design platform, an authorised user may implement a product update in respect of server application 132 and/or client application 142. That is, an authorised user may, via authorised user application 152, implement a product update that includes altering server application 132 and/or altering client application 142. A product update may include one or more product update variants and a product update control. A product update variant refers to a specific version of a product update. In some cases, a product update includes a plurality of product update variants where the specific version corresponding to each product update variant is in some way unique compared to the other versions of other product update variants. For instance, a product update may include the additional of a certain feature that provides a specific functionality which each product update variant presenting that feature in a unique way (e.g. a first product update variant may be a different look of a feature button, a second product update variant may be a different location of the same new-look feature button as in the first product update variant, etc.) In another example, a product update may relate to a number of different features that each provide different functionality, and each product update variant represents a different feature (e.g. a first product update variant may be a first design effect feature, a second product update variant may be a second design effect feature that is a different effect to the first design effect, etc.) A product update control refers to an implementation without any alteration to both server application 132 and client application 142. Thus, in respect of the product update control, the software product is unchanged from a present version of the software product available to the relevant users. The product update control may be used in conjunction with one or more product update variants to serve as a basis of comparison.

In the present disclosure, client application 142 configures the client system 140 to provide a user interface including a graphical user interface (GUI). The GUI allows a user to access and cause other functionality to be performed in respect of server system 130 (e.g. a graphic design platform).

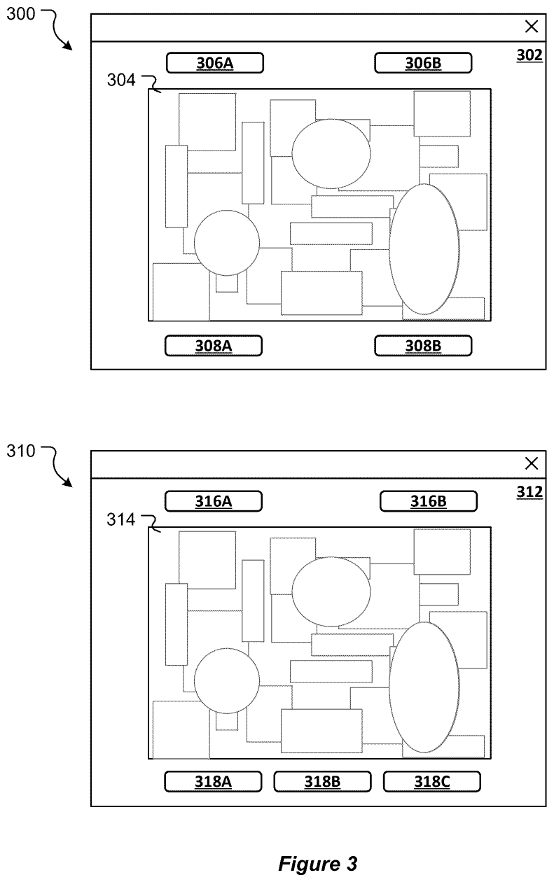

To illustrate the types of features that client application 142 may provide, and in particular to provide an example of a product update control and a product update variant, FIG. 3 provides two versions of example of a user interfaces for a graphic design platform, GUI 300 and GUI 310, that may be generated and displayed to a user (e.g. on a touch screen or other display such as 218). GUI 300 is an example of product update control and GUI 310 is an example of a product update variant.

GUI 300 and GUI 310 each include respective design preview areas 302 and 312. Design preview areas 302 and 312 may, for example, be used to display respective designs 304 and 314 (or, in some cases multiple respective designs) that are each being edited or are to be edited. GUI 300 and GUI 310 also each include respective “load design template” buttons 306A and 316A (to facilitate a user to select and utilise a design template of which they can base their design), and respective “save design” buttons 308A and 318A (to facilitate a user to save their design to a data storage, e.g. within server system 130 or client system 140). GUI 300 and GUI 310 also each include respective first feature control buttons 308A and 318A which, if activated by a user, causes client application 142 to carry out a first specific function (e.g. a first design effect) in respect of designs 304 and 314 (e.g. the displayed designs). GUI 300 and GUI 310 also each include respective second feature control buttons 308B and 318B which, if activated by a user, causes client application 142 to carry out a second specific function (e.g. a second design effect) in respect of designs 304 and 314 (e.g. the displayed designs). GUI 310 further includes a third feature control button 318C which, if activated by a user, causes client application 142 to carry out a third specific function (e.g. a third design effect) in respect of design 314 (e.g. the displayed design).

As can be seen in FIG. 3, GUI 300 and GUI 310 are identical except for the positioning of respective second feature control buttons 308B and 318B and the inclusion of third feature control button 320. Thus, the product update variant of GUI 310 includes a repositioning the second feature control and adding a third feature control button.

For the purposes of monitoring and recording of user interactions, a product update variant (or variants) and a product update control may be provided for use to respective subsets of the total registered users of a software product. For example, a first product update variant may be provided for use to a first subset of registered users such as 5% of total registered users, a second product update variant may be provided for use to a second subset of registered users such as 10% of registered users, and a product update control may be provided for use to a third subset of registered users such as 5% of registered users. In other examples, other subsets of the total registered users may be used for each product update variant and product update control.

Where the authorised user has implemented a product update (including at least one product update variant and a product update control), the authorised user may also define an exposure identifying process. The authorised user may, via authorised user application 152, define an exposure identifying process and the defined exposure identifying process may be implemented (via authorised user application 152) for use by product monitoring platform 110. An exposure identifying process may be used to monitor specific user interactions with the software product to track exposure to users of a product update.

An exposure identifying process includes one or more exposure criteria each of which may be defined similarly to how event schema is defined. That is, an exposure criterion may comprise data representing one or more specific discrete user interactions that a user may be able to perform via client application 142. Thus, where product monitoring platform 110 determines (based on received user interaction event data) that the event schema of a user interaction event matches an exposure criterion, that user interaction event is classified as an exposure event and labelled and identified as such. An exposure event is a user interaction event that indicates that a user has undertaken a specific user interaction denoting that user has been exposed to a product update (i.e. a user has had a product update visually presented to them e.g. by client application 142). Exposure events (being certain instances of user interaction event data) can be used to formulate user metrics. In such cases, these user metrics are specific to user interactions indicating exposure to a product update. These user metrics based on exposure events may be further used to calculate estimations of future user interactions.

Exposure criteria may also include one or more attribute criteria to further filter user interaction event data whereby only user interaction event data having certain attributes will deem its user interaction event as an exposure event. For example, an attribute criteria may be that a user interaction event must have been performed on a certain type of hardware device (i.e. the hardware device attribute must match the attribute criteria specifying a specific hardware device attribute e.g. only user interaction events performed on a desktop computer). In another example, an attribute criteria may be that a user interaction event must have been performed on a certain operating system (i.e. the operating system attribute must match the attribute criteria specifying a specific operating system attribute e.g. only user interaction events performed on iOS). In other embodiments, attribute filtering may be performed independently of an exposure identifying process. i.e. exposure events may not include one or more attribute criteria and instead the exposure events are filtered as a separate process based on attributes of the user interaction event data.

When a product update is implemented (e.g. by an authorised user via authorised user application 152 on authorised system 150), change in user interactions may be estimated by determining a change value distribution. A change value distribution is a measure of probability of relative uplift of user interactions (i.e. a relative increase in positive user interactions and/or relative decrease in negative user interactions) or relative downlift of user interactions (i.e. a relative decrease in positive user interactions and/or relative increase in negative user interactions), which will be explained in detail further below. A change value distribution may be based on a preselected probability model. The preselected probability model may be a statistical model suitable for sequential testing that continuously updates probabilities or inferences based on data collected in real-time. The preselected probability model may additionally or alternatively be a statistical model suitable for providing a relatively accurate result based on a relatively small amount of data and also be suitable for peeking. An example of a suitable preselected probability model is a Bayesian statistics model. In such examples where a Bayesian statistics model, this model may specifically include a preselected distribution type, e.g. gamma distribution. In other embodiments, preselected probability models other than Bayesian model and/or distribution types other than gamma distribution may be used.

The probability model (e.g. Bayesian model) may yield a posterior distribution (e.g. a Bayesian posterior distribution). A posterior distribution may be generated based on a prior distribution and a likelihood factor. The posterior distribution may take the form of a gamma distribution, e.g. a Poisson distribution, an exponential distribution or an exponential and binomial (exponential split) distribution. In other embodiments, other appropriate distributions may be used as the posterior distribution.

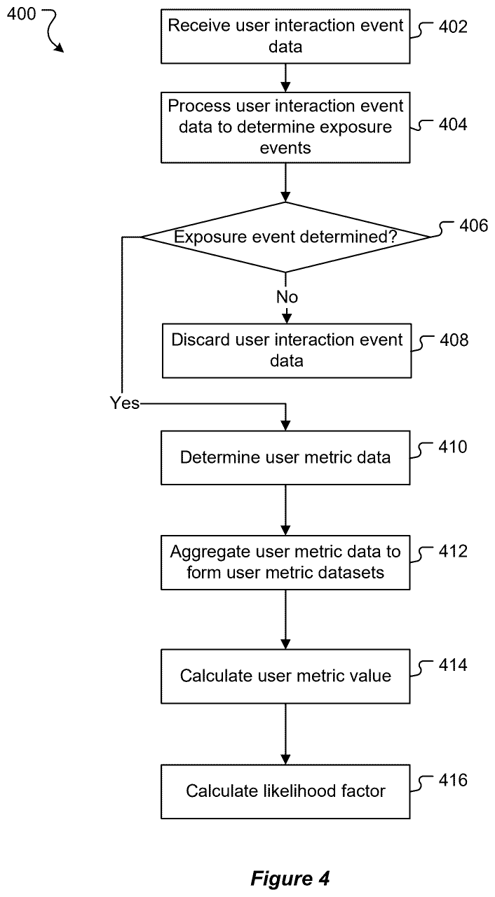

Referring to FIG. 4, a method 400 for determining a likelihood factor for a product update will be described.

The operations of method 400 will be described as being performed by event receiving application 114, event processing application 116, interaction estimation application 118 and data storage application 120 running on hardware 112 of product monitoring platform 110 as well as metric determining system 160. The operations could, however, be performed by one or more alternative applications running on product monitoring platform 110 and/or one or more alternative computer processing systems.

Method 400 is described based on an example product update including a single product update variant (i.e. a single version of the product update, e.g. the product update variant of example GUI 310), an exposure identifying process including a single exposure criterion, and a single user metric. However, as described above, there may be multiple product update variants, an exposure identifying process including multiple exposure criteria, and/or multiple user metrics whereby the above method may be equally applicable. In the present example, the product update variant is provided for use to a first subset of registered users and a product update control may be provided for use by a second subset of registered users.

In the present context, method 400 is performed in respect of user interaction events of the first subset of users and the second subset of users. However, in other embodiments, user interaction events of all registered users may be initially received and method 400 may include a further step of filtering the user interaction events of the first subset of users and the second subset of users from the user interaction events of all registered users. This further step may be carried out by event receiving application 114 (e.g. during or after 402) or event processing application 116 (e.g. during or prior to 404). In other embodiments this further step may be carried out by metric determining system 160 (e.g. during or prior to 410). The filtering process of this further step may be carried out, for example, based on user ID attribute such that the users in either the first subset of users and the second subset of users will be identified based on their respective user ID attributes and only those user's user interaction events will be used to determine the likelihood factor.

At 402, product monitoring platform 110 receives user interaction event data, i.e. one or more instances of generated user interaction event data based on one or more user interaction events. In the present example where user interaction event data is generated by one or more client systems (e.g. client system 140), each instance of user interaction event data may be received following occurrence of a respective user interaction event. This is such that the product monitoring platform effectively receives instances of generated user interaction event data in real-time immediately following a user interaction event occurrence. Event receiving application 114 collects each instance of user interaction event data that is received and may store this data in data storage (e.g. in data storage 122, via data storage application 120).

At 404, the user interaction event data (i.e. instances of generated user interaction event data) collected by event receiving application 114 is processed by event processing application 116 to determine if the user interaction event data (i.e. each instance of user interaction event data) is related to a user interaction event that is an exposure event. Event processing application 116 makes this determination by carrying out a predefined exposure identifying process based on a predefined exposure criterion or criteria. Thus, event processing application 116 determines based on the predefined exposure identifying process whether or not an event schema of a user interaction event matches the predefined exposure criteria. Based on the predefined exposure identifying process, event processing application 116 determines whether or not a user interaction event (from which an instance of generated user interaction event data is based) is an exposure event at 406.

A certain exposure criterion may include a user selecting any button presented to the user. In the examples of FIG. 3, these include buttons 306A, 306B, 308A and 308B of the product update control GUI 300 and buttons 316A, 316B, 318A, 318B and 318C of the product update variant GUI 310. Thus, any user interaction event where its event schema is a user interacting with (e.g. selecting) any button presented to the user will be classified as an exposure event (and labelled and thus identified as such). In another embodiment, an exposure criterion may additionally include attribute criteria. For example, event processing application 116 may only wish to retrieve user interaction events performed on a certain operating system, e.g. iOS.

If, at 406, event processing application 116 determines that a user interaction event from which an instance of generated user interaction event data is based is not determined to be an exposure event, at 408, the instance of user interaction event data is discarded (at least for the purposes of techniques described herein). If event processing application 116 determines that a user interaction event from which an instance of generated user interaction event data is based is determined to be an exposure event, event processing application 116 stores this data (including its time stamp attribute) as exposure event data in data storage (e.g. in data storage 122, via data storage application 120). For clarity, exposure event data may be equivalent to the user interaction event data from which it is based aside from being classified and stored as exposure event data (and labelled and thus identified as such). Event processing application 116 may then send the exposure event data (i.e. one or more instances of exposure event data) to metric determining system 160 (e.g. via network 170).

At 410, metric determining system 160 receives the exposure event data (i.e. one or more instances of exposure event data) and metric determining system 160 processes the received exposure event data to determine if the exposure event data (i.e. each instance of exposure event data) is relevant to a user metric. If metric determining system 160 determines that an instance of exposure event data is relevant to a user metric, that instance of exposure event data is determined to be an instance of user metric data. For clarity, user metric data may be equivalent to the exposure event data from which it is based aside from being classified as user metric data (and labelled and thus identified as such).

In the examples of FIG. 3, a user metric A may be a number of distinct times a feature control button (e.g. for the product update control GUI 300, feature control buttons 306 or 308, and for the product update variant GUI 310 a feature control buttons 316, 318 or 320) was used. Thus, where an exposure event includes a user selecting a feature control button (thus indicating a corresponding feature was used), this exposure event will be classified as an instance of user metric data in respect of user metric A.

In present examples, metric determining system 160 may be an analytics building platform (e.g. Tinybird) based on a database management system, (e.g. ClickHouse). Metric determining system 160 may be pre-configured from an authorised user system e.g. 150, the pre-configuration implemented by an authorised user via authorised user application 152. In embodiments where metric determining system 160 is implemented as part of product monitoring platform 110, the functionality of metric determining system 160 described herein may be performed by a further metric processing application, or integrated within the functionality of an existing application such as event processing application 116. In yet other embodiments, the functionality of metric determining system 160 described herein may be at least performed by other systems (either described herein or not shown) based on specific requirements. For example, where there are a plurality of user metrics, a first metric determining system may determine first user metric data for a user metric A, a second metric determining system may determine second user metric data for a user metric B, and so on.

In alternative embodiments, 410 may be performed by event processing application 116, i.e. event processing application 116 may process the exposure event data to determine if the exposure event data (i.e. each instance of exposure event data) is relevant to a user metric and thus is user metric data. The user metric data is then sent to metric determining system 160 (e.g. via network 170).

Once metric determining system 160 determines (or in the above alternate embodiment receives) the user metric data (i.e. one or more instances of user metric data) in respect of the user metric, at 412 metric determining system 160 aggregates the user metric data to form a user metric dataset for each of the product update variant and product update control. The user metric dataset in respect of the user metric for the product update variant may be referred to herein as a user metric variant dataset and user metric dataset in respect of the user metric for the product update control may be referred to herein as a user metric control dataset. In embodiments where there are multiple product update variants, the respective user metric datasets for each variant may be referred to as a first user metric variant dataset, a second user metric variant dataset, and so on. For simplicity, the term “user metric dataset” may be used when the techniques described herein are applicable to either the user metric variant dataset or the user metric control dataset.

In the examples of FIG. 3, a user metric control dataset relates to user interactions in respect of feature control buttons 308A or 308B and a user metric variant dataset relates to user interactions in respect of feature control buttons 318A, 318B or 318C.

The user metric datasets may be aggregated by metric determining system 160 based on a predefined time period parameter. The predefined time period parameter may define which of the one or more instances of user metric data may be included in the user metric datasets. Metric determining system 160 carries out this aggregation based on the time stamp attribute of each instance of user metric data such that if the time stamp attribute of an instance of user metric data is within a predefined time period defined by the predefined time period parameter, this instance of user metric data is included in the user metric datasets. Thus, each instance of user metric data having its time stamp attribute within a predefined time period defined by the predefined time period parameter collectively forms the user metric dataset in respect of the user metric. That is, the user metric variant dataset includes instances of user metric data for the product update variant, the user metric data having its time stamp attribute within a predefined time period. And the user metric control dataset includes instances of user metric data for the product update control, the user metric data having its time stamp attribute within a predefined time period.

The predefined time period defined by the predefined time period parameter may be selected as desired by an authorised user that may communicate this predefined time period parameter (e.g. via authorised user application 152) to product monitoring platform 110. For example, an authorised user may select the predefined time period and thus set the predefined time period parameter when implementing a product update. In other embodiments, the predefined time period parameter may be set based on other factors, e.g. there may be a standard predefined time period that is used for all product updates. In present examples, the predefined time period may be 24 hours. In other embodiments, the predefined time period may be other than 24 hours, for example 12 hours, 48 hours, or 72 hours. In alternative embodiments, there may be a plurality of standard predefined time periods that may be used for specific metrics, e.g. where the user metric is a number of distinct trials of or subscriptions to the graphic design platform that are commenced, the predefined time period may be greater (e.g. 72 hours) than for the user metric being a number of distinct times a certain feature of the graphic design platform was used (e.g. 24 hours) as the latter would generally have far more instances of user interactions than the former.

Once metric determining system 160 forms the user metric variant dataset and the user metric control dataset, at 414, metric determining system 160 may then use these formed user metric datasets to calculate a user metric value for each of the product update variant and product update control. The user metric value in respect of the user metric for the product update variant may be referred to herein as a user metric variant value and user metric value in respect of the user metric for the product update control may be referred to herein as a user metric control value. In embodiments where there are multiple product update variants, the respective user metric values for each variant may be referred to as a first user metric variant value, a second user metric variant value, and so on. For simplicity, the term “user metric value” may be used when the techniques described herein are applicable to either the user metric variant value or the user metric control value.

The user metric value may be a cumulative count of the number of instances of user metric data in the user metric dataset. Thus, the user metric variant value represents the number of relevant user interaction events that occurs within the predefined time period for the product update variant (i.e. the number of instances of user metric data in the user metric variant dataset) and the user metric control value represents the number of relevant user interaction events that occurs within the predefined time period for the product update control (i.e. the number of instances of user metric data in the user metric control dataset).

For each of the product update variant and product update control, metric determining system 160 may also cumulatively count and store a number of exposed users, that is a total number of registered users for each of the first subset of registered users and the second subset of registered users that carried out at least one exposure event. Further, for each of the product update variant and product update control, metric determining system 160 may also cumulatively count and store a number of exposed users contributing to the user metric, that is a total number of registered users for each of the first subset of registered users and the second subset of registered users that carried out at least one exposure event that is relevant to the user metric. Metric determining system 160 may carry out these cumulative counts based on the number of different unique user IDs associated with each instance of user metric data in the user metric datasets.

Certain user interaction events may be able to occur multiple times for a single user, e.g. using a certain feature of the graphic design platform. Other user interaction events may only be able to occur once for a single user, e.g. commencing a one-time only trial of the graphic design platform. Therefore, user metrics based on user interaction events that may be able to occur multiple times may yield a user metric value that exceeds the number of exposed users contributing to the user metric and may also exceed the number of exposed users. For instance, for the example user metric A for a product update variant, the number of exposed users may be 15, the number of exposed users contributing to the user metric may be 10, and the user metric value may be 20 (indicating that one or more of the exposed users contributing to the user metric used a relevant feature multiple times during the predefined time period).

The user metric variant value, the number of exposed users for the product update variant and the number of exposed users contributing to the user metric for the product update variant may be collectively referred to as variant probability input data. The user metric control value, the number of exposed users for the product update control and the number of exposed users contributing to the user metric for the product update control may be collectively referred to as control probability input data. In embodiments where there are multiple product update variants, the respective variant probability input data for each variant may be referred to as first variant probability input data, second variant probability input data, and so on. For simplicity, the term “probability input data” may be used when the techniques described herein are applicable to either the variant probability input data or the control probability input data. Metric determining system 160 sends the variant probability input data and the control probability input data to product monitoring platform 110 (e.g. via network 170).

Interaction estimation application 118 receives the variant probability input data and the control probability input data from metric determining system 160 and, at 416 interaction estimation application 118 calculates a likelihood factor for each of the product update variant and the product update control. The likelihood factor in respect of the product update variant may be referred to herein as a variant likelihood factor and the likelihood factor in respect of the product update control may be referred to herein as a control likelihood factor. In embodiments where there are multiple product update variants, the respective likelihood factors for each variant may be referred to as a first variant likelihood factor, a second variant likelihood factor, and so on. For simplicity, the term “likelihood factor” may be used when the techniques described herein are applicable to either the variant likelihood factor or the control likelihood factor.

In cases where there is an unequal number of users in the first subset and the second subset, prior to 416, interaction estimation application 118 may apply respective scaling factors (i.e. respective variant scaling factor and control scaling factor) to the variant probability input data and the control probability input data to calculate scaled variant probability input data and scaled control probability input data. In present examples, an applied scaling factor may be an assignment probability, i.e. the probability of a user being assigned to a certain subset of registered users, compared to another subset of registered users. Scaling factors thus may be calculated based on the percentage of total registered users in a subset of registered users and must add up to 1 across all subsets of registered users. In a present example, the first subset of registered users (provided with the product update variant) may be 5% of total registered users and the second subset of registered users (provided with the product update control) may also be 5% of total registered users. Thus, relative ratio of the first subset to the second subset is 1:1, and thus the assignment probability for the first subset is 0.5 and the assignment probability for the second subset is 0.5 also. In another example, the first subset of registered users (provided with the product update variant) may be 5% of total registered users and the second subset of registered users (provided with the product update control) may also be 10% of total registered users. Thus, relative ratio of the first subset to the second subset is 1:2, and thus the assignment probability for the first subset is 0.333 and the assignment probability for the second subset is 0.667.

The respective assignment probabilities (i.e. variant scaling factor and control scaling factor) are applied to the variant probability input data and the control probability input data to respectively calculate scaled variant probability input data and scaled control probability input data. The assignment probabilities are applied by dividing the variant probability input data (that is, each of the user metric variant value, the number of exposed users for the product update variant and the number of exposed users contributing to the user metric for the product update variant) and the control probability input data (that is, each of user metric control value, the number of exposed users for the product update control and the number of exposed users contributing to the user metric for the product update control) the respective assignment probabilities. For example, for the example where the variant probability input data is as follows: the number of exposed users is 15; the number of exposed users contributing to the user metric is 10; and the user metric value is 20, and the assignment probability for the variant probability input data is 0.5, the scaled variant probability input data will be as follows: scaled number of exposed users is 30 (i.e. 15/0.5); scaled number of exposed users contributing to the user metric is 20 (i.e. 10/0.5); and scaled user metric value is 40 (i.e. 20/0.5). By applying scaling factors, comparisons between a product update variant and a product update control can be accurately made.

The variant likelihood factor and control likelihood factor may be respectively derived from the scaled variant probability input data and the scaled control probability input data (or the variant probability input data and the control probability input data if scaling is not required). The calculation of the likelihood factors is dependent on the specific type of posterior distribution of which the likelihood factor is used. In one example where the posterior distribution is an exponential distribution, the scaled probability input data is used to calculate an average of user interactions contributing to each user metric value per exposed user. More specifically, the variant likelihood factor may be calculated by dividing the user metric variant value by the number of exposed users for the product update variant and the control likelihood factor may be calculated by dividing the user metric control value by the number of exposed users for the product update control. In examples where the posterior distribution is an exponential and binomial distribution the likelihood factors will be based on the user metric variant value, the number of exposed users contributing to the user metric (i.e. an exponential parameter for each of the product update variant and product update control calculated by dividing the respective user metric values by the respective number of exposed users contributing to the metric) and the number of exposed users (i.e. a first and second binomial parameter for each of the product update variant and product update control, the respective first binomial parameters being the respective number of exposed users and the respective second binomial parameter calculated by dividing the respective number of exposed users contributing to the metric by the respective number of exposed users).

The selection of the probability distribution may, in one example, be pre-selected by an authorised user via authorised user application 152 of authorised user system 150 for input into product monitoring platform 110. In another example, the selection of the probability distribution may be selected by interaction estimation application 118, the selection being based on the specific user metric. The selection of the probability distribution used may be based on the specific user metric. For instance, where the user metric generally yields a typical user metric value per exposed user (for example in the range of 0.001 to 0.005) such as a number of distinct times a certain feature of the graphic design platform was used or a number of distinct times a graphic design template was accessed, an exponential distribution may be used given the relative computational execution speed is higher than the computational execution speed using other distributions. However, where the user metric generally yields a must lower than typical user metric value per exposed user (for example in the range of 0.0005 to 0.0009) such as a number of distinct trials of or subscriptions that are commenced, an exponential and binomial distribution may be used as it is able to detect variations on a smaller scale to a typical user metric which would otherwise be harder to detect using other distributions (but performs at a slower execution speed relative to using an exponential distribution).

Event receiving application 114, event processing application 116, interaction estimation application 118, data storage application 120 and metric determining system 160 may be configured to perform method 400 (or certain operations thereof) at various times. For example, event receiving application 114, event processing application 116, interaction estimation application 118, data storage application 120 and metric determining system 160 may be configured to automatically perform method 400 at regular time intervals—for example about every five minutes, every ten minutes, every thirty minutes, every hour, or at any other time interval. Alternatively, event receiving application 114, event processing application 116 and data storage application 120 may be configured to perform 402, 404, 406 and 408 at a first time interval and interaction estimation application 118 and metric determining system 160 may be configured to perform 410, 412, 414 and 416 at a second time interval whereby the first time interval is less than the second time interval (i.e. 402, 404, 406 and 408 are performed more frequently than 410, 412, 414 and 416). For example, the first time interval may be substantially equivalent to real time and the first time interval may be about ten minutes. In such cases, interaction estimation application 118 (or event processing application 116) may trigger the exposure event data (i.e. one or more instances of exposure event data) may be sent to metric determining system 160 to commence 410.

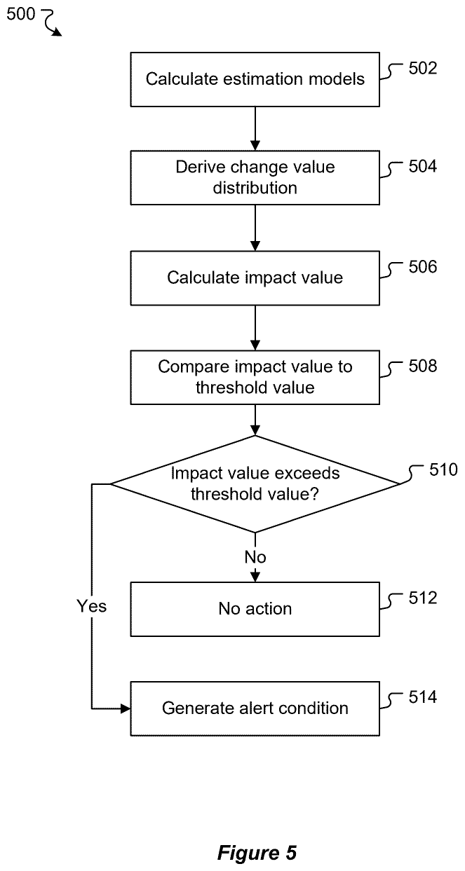

Turning to FIG. 5, a method 500 for generating an alert in respect of a product update will be described. An alert indicates that the product update is expected to have a particularly negative impact on user interactions (i.e. that the product update variant is estimated to perform worse than the product update control in respect of a particular user metric).

Method 500 will be described as being performed by interaction estimation application 118 running on hardware 112 of product monitoring platform 110. The operations could, however, be performed by one or more alternative applications running on product monitoring platform 110 and/or one or more alternative computer processing systems.

In the present context, method 500 may be performed after the completion of method 400. As such, method 500 will be described based on the examples used in respect of method 400. More specifically, method 500 is also described based on a product update including a single product update variant (i.e. a single version of the product update, e.g. the product update variant of example GUI 310) and a single user metric. However, as described above, there may be multiple product update variants and multiple user metrics whereby method 500 may be equally applicable.

In the present context, method 500 takes as an input: variant likelihood factor and control likelihood factor (e.g. as calculated at 416 of method 400); and a prior distribution of each of the product update variant and the product update control. The prior distributions may be selected (e.g. by an authorised user via authorised user application 152 on authorised system 150) for inputting into product monitoring platform 110. In one embodiment, the selection of the prior distributions may be based on prior data (e.g. prior user interaction events in respect of a specific user metric). In another embodiment, the selection of the prior distributions may be based on an estimation of the expected distribution (e.g. an expected distribution for a specific user metric). In present examples, the prior distributions are gamma distributions. However, in other embodiments, the prior distributions may be other types of distributions such as a normal distribution.

At 502, interaction estimation application 118 receives the inputted prior distribution of each of the product update variant and the product update control and the inputted variant likelihood factor and control likelihood factor (e.g. as calculated at 416 of method 400) and calculates estimation models in the form of posterior distributions for each of: the product update variant (based on the variant likelihood factor and the prior distribution of the product update variant) referred to as a variant estimation model; and the product update control (based on the control likelihood factor and the prior distribution of the product update control) referred to as a control estimation model. For simplicity, the term “estimation model” may be used when the functionality described herein is applicable to either the variant estimation model or the control estimation model. The estimation models calculated are based on a preselected probability model. The preselected probability model, similar to the change value distribution model, may be a statistical model suitable for sequential testing that continuously updates probabilities or inferences based on data collected in real-time. The preselected probability model may additionally or alternatively be a statistical model suitable for providing a relatively accurate result based on a relatively small amount of data and also be suitable for peeking. An example of a suitable preselected probability model is a Bayesian statistics model. In other embodiments, suitable preselected probability models other than Bayesian model may be used.

As stated above, a posterior distribution may be generated based on a prior distribution and a likelihood factor. For example, a posterior distribution (or more specifically, an approximation thereof) may be calculated as follows:

$$posterior distribution ≅ ( likelihood factor * prior distribution )$$

That is, for each of the product update variant and the product update control, the respective posterior distributions (or approximations thereof) are calculated by: sampling a prior distribution (i.e. selecting a prior distribution) and then updating this prior distribution with the likelihood factor to obtain the posterior distribution. In certain examples, predefined statistical software may be used to calculate posterior distributions, e.g. scipy.stats in Python. For the purposes of the present disclosure, the term “posterior distribution” may refer to an approximation of posterior distribution in certain contexts where appropriate.

In some embodiments, an approximation of posterior distribution may be divided by an evidence factor in the form of a constant, i.e. a normalising constant, to obtain an actual posterior distribution. However, for the present applications discussed herein, an approximation of posterior distribution is sufficient. In examples where the prior distributions are gamma distributions, the resultant posterior distributions are also gamma distributions.

At 504, interaction estimation application 118 uses the variant estimation model and control estimation model (calculated at 502) to derive an estimation of change of user interactions in the form of a change value distribution. A change value distribution indicates if there is a relative uplift of user interactions (i.e. an increase in positive user interactions/decrease in negative user interactions) or a relative downlift of user interactions (i.e. a decrease in positive user interactions/increase in negative user interactions). In the present context, a change value distribution provides a relative difference in the use metric between the product update control and the product update variant.

For example, the following equation may be used to calculate the change value distribution:

$$Change value distribution = ( variant estimation model / control estimation model ) - 1$$

The change value distribution is thus calculated based on each corresponding sample value of the variant estimation model and the control estimation model to obtain this posterior distribution. Such sampling may be through standard sampling processes, e.g. using Markov chain Monte Carlo or similar techniques. Thus, for a positive user metric, a change value of the change value distribution will thus be positive (i.e. an uplift) if the corresponding sample of the variant estimation model is greater than the corresponding sample of the control estimation model, or negative (i.e. a negative uplift or downlift) if the corresponding sample of the variant estimation model is less than the corresponding sample of the control estimation model. For a negative user metric, a change value of the change value distribution will thus be positive (i.e. an uplift) if the corresponding sample of the variant estimation model is less than the corresponding sample of the control estimation model, or negative (i.e. a negative uplift or downlift) if the corresponding sample of the variant estimation model is greater than the corresponding sample of the control estimation model. If the change value is an uplift, this may be taken as an indication that the product update is causing an increase in user interactions with the software product (i.e. making a positive impact). If the change value is a downlift, this may be taken as an indication that the product update is causing a decrease in user interaction with the software product (i.e. making a negative impact).

Once the change value distribution is derived (at 504), at 506 interaction estimation application 118 uses this change value distribution to calculate an impact value. A positive impact value represents an increase in a positive user metric and/or a decrease in a negative user metric that a product update may have on user interactions and a negative impact value represents a decrease in a positive user metric and/or an increase in a negative user metric that a product update may have on user interactions. In the present context, only negative impact value s are of interest and are thus considered for further processing by interaction estimation application 118. The magnitude of the negative impact (i.e. how great of a negative impact is estimated) is also considered.

A negative impact value is an aggregation of all negative values sampled from a statistical distribution (e.g. the change value distribution) multiplied by the probability of a value being a negative value. In present examples, the impact value may be derived from the change value distribution (derived at 504). For example, in respect of a positive user metric, a negative impact value calculated at a specific time/may be defined by the following equation (which takes into account the lower metric value of the positive user metric conferring a more negative outcome):

$$Negative impact value at time t = ( - 1 ) * avg ( change values where < 0 ) * count ( change values where < 0 ) / count ( all values )$$

In the above example equation, avg(uplift values where<0) is the mean of all change values that are less than zero (i.e. negative values sampled) up to time t, count(uplift values where<0) is the count of change values that are less than zero (i.e. negative values sampled) up to time t, and count(all values) is the count of all values (whether positive or negative) up to time t. “(−1)*avg(change values where<0)” may also be defined as: the absolute value of avg(change values where<0).

In respect of a negative user metric, a negative impact value may be similarly defined by the following equation (which takes into account the higher metric value of a negative user metric conferring a more negative outcome):

$$Negative impact value at time t = avg ( uplift values where > 0 ) * count ( uplift values where > 0 ) / count ( all values )$$

Once the negative impact value (also referred to herein as “impact value” given only negative impact values are considered) is calculated (at 506), at 508 interaction estimation application 118 compares the impact value to an established impact value threshold. The impact value threshold may be established by an authorised user (e.g. via authorised user application 152 on authorised system 150) for inputting into product monitoring platform 110. The impact value threshold may be calculated based on two impact value threshold components, those being: a minimum uplift detection threshold; and a negative outcome probability threshold. The minimum uplift detection threshold is a threshold value corresponding to avg(uplift values where<0) (for positive user metrics) or avg(uplift values where<0) (for negative user metrics). This threshold is a setting representing the minimum detectable relative uplift. In embodiments, the minimum uplift detection threshold may be a value between 0 and 1 that is set for all user metrics (e.g. 0.05 meaning a 5% minimum detectable relative uplift). In other embodiments, the minimum uplift detection threshold may be customised for each user metric (which reflects differing tolerances of degradation over time for each metric). The negative outcome probability threshold is a threshold value corresponding to count(uplift values where<0)/count(all values) (for positive user metrics) or count(uplift values where<0)/count(all values) (for negative user metrics). This threshold is a setting representing the probability of negative impacts which may be expressed as a value between 0 and 1 (e.g. 0.95 meaning a 95% probability of negative impacts).

The impact value threshold may be calculated by multiplying the negative outcome probability threshold by the minimum uplift detection threshold. Using the above example threshold components, the impact value threshold in this instance is 0.95*0.05=0.0475. Based on the impact value threshold, interaction estimation application 118 determines whether or not the calculated impact value (at time t), exceeds the impact value threshold at 510.

If, at 510, interaction estimation application 118 determines that the calculated impact value does not exceed the impact value threshold, at 512, no further action is taken (at least for the purposes of techniques described herein). If interaction estimation application 118 determines that the calculated impact value does exceed the impact value threshold, this may deem the product update to yield an alert condition. An alert condition may indicate a higher than acceptable predicted negative impact in respect of a product update based on the specific user metric. Thus, an alert condition may be generated when the impact value for a positive user metric or a negative user metric exceeds the impact value threshold.

Where an alert condition is yielded, at 514 interaction estimation application 118 may then generate an alert. Such an alert may be initiated by interaction estimation application 118 to be communicated to authorised user system 150 (e.g. via network 170). The alert may be in the form of an instant message, an email, or other means. An authorised user may then respond to the alert where subsequent action may be taken. In other embodiments, an alert condition may trigger other actions. For example, other actions may include generating an impact report including data such as the impact value and impact value threshold. Such a report may be sent to authorised user system 150 to be viewed by an authorised user. In another example, where there are multiple product update variants, an impact report may include information in respect of each product update variant such as comparative impact values (this may include impact values of product update variants that have not generated an alert) amongst other data.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

In the embodiments described above, processing may be performed by applications 114, 116, 118 and 120 running on a computer processing hardware 112. Alternatives are, however, possible.

For example, one or more of applications 114, 116, 118 and/or 120 may be software modules of a single application to perform the described techniques. In another example, one or more of applications 114, 116, 118 and/or 120 may be performed on separate interoperating computer processing systems to perform the described techniques.

As another example, the functions performed by applications 114, 116, 118 and/or 120 may be combined together in a product monitoring package that can be used to extend the functionality provided by an existing application (as one example, the functionality provided by authorised user application 152 of authorised user system 150). In this case the product monitoring package may be locally installed on a given system, e.g. as a plug-in or extension to an existing application (such as authorised user application 152).

As yet another example, the functions performed by applications 114, 116, 118 and/or 120 may be combined together in a product monitoring service that can be accessed by any appropriate application (e.g. a web browser or other application).

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

In certain instances the present disclosure may use the terms “first,” “second,” etc. to describe various features. Unless stated otherwise, these terms are used only to distinguish features from one another and not in an ordinal sense. For example, and unless context requires otherwise, a first feature could be termed a second feature or vice versa without departing from the scope of the described examples. Furthermore, when the terms “first”, “second”, etc. are used to differentiate features rather than indicate order, a second feature could exist without a first feature. For example, a second feature could occur before a first feature (or without a first feature ever occurring/existing).

Certain features of the present disclosure are explicitly described as being optional. If a particular feature is not explicitly described as being optional, however, this is not intended to indicate that the feature is essential or required. In many cases a feature that is not explicitly described as being optional may be omitted or may be substituted with a variation of the feature as described.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

### Glossary

registered users: users of a software product that may be able to access and utilise the functionality of the software product
authorised user: an administrator/technician (or the like) of a software product
product update: any feature change or new feature added to a software product that may be implemented by an authorised user, may include one or more product update variants and a product update control
product update variant: a specific version of a product update of a software product
product update control: an implementation of a software product without any alteration
user interaction event: user interaction(s) with a software product, defined by an event schema
user interaction event data: data generated in response to a user interaction event, including various attributes
user metric: a statistical count of certain user interaction events (based on based on user interaction event data) having a value referred to as a ‘user metric value’
user metric data: an instance of user interaction event data used to calculate a user metric
user metric dataset: one or more instances of user metric data
user metric variant dataset: one or more instances of user metric data in respect of a product update variant
user metric control dataset: one or more instances of user metric data in respect of a product update control
positive user metric: user metric based on user interaction events that are deemed to be positive to the user experience or engagement in relation to the software system
negative user metric: user metric based on user interaction events that are deemed to be negative to the user experience or engagement in relation to the software system
event schema: data describing or descriptor of the user interaction of a user interaction event, that may represent a specific discrete user interaction
user interaction event occurrence: when a performed user interaction matches the event schema of that user interaction event
time stamp attribute: data representing the time at which the associated user interaction event occurred
user ID attribute: data representing the user ID of the registered user associated with a user interaction event
user device ID attribute: data representing the user device ID of the specific client system associated with a user interaction event
hardware device attribute: data representing the hardware device upon which the software product is running e.g. mobile phone, tablet, desktop computer
operating system attribute: data representing the operating system software upon which the software product is running e.g. iOS, Android
exposure identifying process: process to monitor specific user interactions with the software product defined by an authorised user, including one or more exposure criteria
exposure criteria: data representing one or more specific discrete user interactions, defined similarly
to event schema, may also include one or more attribute criteria exposure event: a user interaction event where its event schema matches an exposure criteria, indicating that a user has undertaken a specific user interaction denoting that user has been exposed
to a product update attribute criteria: filtering criteria upon which only user interaction event data having certain attributes will deem its user interaction event as an exposure event. attribute criteria may relate to certain hardware device attribute or operating system attribute
exposure event data: an instance of user interaction event data determined to be for an exposure event
user metric data: an instance of exposure event data relevant to a user metric
user metric dataset: all instances of user metric data in respect of the user metric for the product update
user metric variant dataset: all instances of user metric data in respect of the user metric for the product update variant
user metric control dataset: all instances of user metric data in respect of the user metric for the product update control
predefined time period parameter: data defining a predefined time period within which of the one or more instances of user metric data may be included in the user metric datasets based on the time stamp attribute of each instance of user metric data
user metric value: a cumulative count of the number of instances of user metric data in the user metric dataset
user metric variant value: user metric value in respect of a user metric variant dataset
user metric control value: user metric value in respect of a user metric control dataset
member of exposed users: a total number of registered users that carried out at least one exposure event
member of exposed users contributing to the user metric: a total number of registered users that carried out at least one exposure event that is relevant to the user metric
probability input data: data set collectively including the user metric value, the number of exposed users and the number of exposed users contributing to the user metric
variant probability input data: probability input data in respect of the product update variant
control probability input data: probability input data in respect of the product update control
scaling factor: a value, that may be an assignment probability, used to scale probability input data in view of non-equal users for each of the product update variant and product update control, to allow more meaningful comparison to each other
variant scaling factor: scaling factor in respect of the product update variant
control scaling factor: scaling factor in respect of the product update control
scaled probability input data: probability input data after which a scaling factor has been applied scaled variant probability input data: scaled probability input data in respect of the product update variant
scaled control probability input data: scaled probability input data in respect of the product update control
likelihood factor: a component used with a statistical distribution such as a prior distribution to calculate a posterior distribution, this component being derived from probability input data/scaled probability input data
variant likelihood factor: likelihood factor in respect of the product update variant
control likelihood factor: likelihood factor in respect of the product update control
estimation model: a statistical distribution such as a posterior distribution based on the likelihood factor and the prior distribution
variant estimation model: estimation model in respect of the product update variant (based on the variant likelihood factor and the prior distribution of the product update variant)
control estimation model: estimation model in respect of the product update control (based on the control likelihood factor and the prior distribution of the product update control)
change value distribution: statistical distribution such as a posterior distribution representing a measure of relative uplift of user interactions or relative downlift of user interactions
impact value: represents a measure of potential positive or negative impact that a product update may have on user interactions, calculated based on the change value distribution at a certain time t
impact value threshold: a threshold value for comparison of an impact value upon which an alert may be generated, may be made up of the following components: minimum uplift detection threshold; and negative outcome probability threshold
minimum uplift detection threshold: a threshold value that may be between 0 and 1 representing the minimum detectable relative uplift (corresponding to avg(uplift values where<0) for positive user metrics or avg(uplift values where<0) for negative user metrics)
negative outcome probability threshold: a threshold value that may be between 0 and 1 representing the probability of negative impacts (corresponding to count(uplift values where<0)/count(all values) for positive user metrics count(uplift values where<0)/count(all values) for negative user metrics)

1. A computer implemented method for generating an alert based on a product update for a software system, the product update including a first product update variant of the software system and a product update control of the software system, the method including:
receiving user interaction event data based on one or more user interaction events from a plurality of users of the software system, the plurality of users including a first subset of users using the first product update variant and a second subset of users using the product update control;
processing the user interaction event data to determine if any of the one or more user interaction events is an exposure event;
based on the user interaction event data of any determined exposure events, determining, for each of the first product update variant and product update control, a respective user metric dataset for a user metric;
calculating, for the first product update variant and product update control, respective probability input data in respect of the user metric based on the respective user metric datasets;
based on the probability input data, calculating, for the first product update variant and product update control, a first variant estimation model and a control estimation model respectively;
deriving a first change value distribution based on the first variant estimation model and the control estimation model such that the first change value distribution defines probability of relative uplift or downlift of user interactions;
calculating a first impact value based on first change value distribution and a predefined time value t;
comparing the calculated first impact value with a predefined impact value threshold; and
based on this comparison, generating a first alert condition.

2. The computer implemented method of claim 1, wherein the first variant estimation model and the control estimation model are statistical models suitable for sequential testing based on real-time data collection.

3. The computer implemented method of claim 1, wherein the first variant estimation model and the control estimation model are Bayesian statistical models.

4. The computer implemented method of claim 1, wherein the software system includes a plurality of original features and the first product update variant includes at least one of: a feature change of at least of one the plurality of original features; and at least one new feature in addition to the plurality of original features and the product update control includes only the plurality of original features.

5. The computer implemented method of claim 1, wherein the respective probability input data includes, for each of the first product update variant and product update control, respective user metric values representing the number of respective exposure events that contribute to the user metric.

6. The computer implemented method of claim 5, wherein the respective user metric values represent the number of relevant user interaction events that occurs within a predefined time period.

7. The computer implemented method of claim 5, wherein the respective probability input data, for each of the first product update variant and product update control, further includes:
a count of number of exposed users for each of the first product update variant and product update control; and
a count of the number of exposed users contributing to the user metric for each of the first product update variant and product update control.

8. The computer implemented method of claim 1, wherein user interaction event data includes a time stamp attribute and determining respective user metric datasets is based on the time stamp attribute of the user interaction event data such that the time stamp attribute is within a predefined time period defined by a predefined time period parameter.

9. The computer implemented method of claim 1, wherein user interaction event data based on one or more user interaction events is received substantially in real time immediately following a user performing a user interaction event.

10. The computer implemented method of claim 1, wherein calculating the first variant estimation model and the control estimation model includes calculating respective likelihood factors based on the respective user metric values.

11. The computer implemented method of claim 10, wherein the first variant estimation model and the control estimation model are respective posterior distributions calculated based on the respective likelihood factors.

12. The computer implemented method of claim 10, wherein the respective likelihood factors for the first variant estimation model and the control estimation model are respectively derived from the probability input data for the first product update variant and the probability input data for the product update control.

13. The computer implemented method of claim 1, following the generation of the first alert condition, further including generating and communicating an alert to an authorised user of the software system.

14. The computer implemented method of claim 1, wherein the user metric includes a positive user metric based on user interaction events that are deemed to be positive to user experience or engagement in relation to the software system and a negative user metric based on user interaction events that are deemed to be negative to user experience or engagement in relation to the software system.

15. The computer implemented method of claim 1, including, for each of the first product update variant and product update control, applying respective scaling factors to the respective probability input data based on the first subset of users and the second subset of users.

16. The computer implemented method of claim 1, wherein the product update includes a second product update variant of the software system, the plurality of users including a third subset of users using the second product update variant, including:
determining a user metric dataset for the second product update variant:
calculating, for the second product update variant, probability input data in respect of the user metric based on the user metric datasets for the second product update variant and the product update control;
based on the probability input data, calculating, for the second product update variant and product update control, a second variant estimation model;
deriving a second change value distribution based on the second variant estimation model and the control estimation model such that the second change value distribution defines probability of relative uplift or downlift of user interactions;
calculating a second impact value based on the second change value distribution and a predefined time value t;
comparing the calculated second impact value with a predefined impact value threshold; and
based on this comparison, generating a second alert condition.

17. The computer implemented method of claim 16, wherein the second variant estimation model is a statistical model suitable for sequential testing based on real-time data collection.

18. The computer implemented method of claim 16, wherein the first and/or second alert condition are generated where the comparison outcome represents a sufficiently high negative impact of the corresponding product update variant compared to the product update control.

19. A computer processing system including:
one or more computer processing units; and
non-transitory computer-readable medium storing instructions which, when executed by the one or more computer processing units, cause the one or more computer processing units to perform a method according to claim 1.

20. Non-transitory storage storing instructions executable by one or more computer processing units to cause the one or more computer processing units to perform a method according to claim 1.
